(19) United States
(12) Patent Application Publication
(10) Pub. No.: US 2020/0117691 A1
(43) Pub. Date: Apr. 16, 2020

(54) SEARCH MINING METHOD, APPARATUS, STORAGE MEDIUM, AND ELECTRONIC DEVICE

(71) Applicant: ALIBABA GROUP HOLDING LIMITED, Grand Cayman (KY)

(72) Inventors: Liansheng SUN, HANGZHOU (CN); Zhenxin MA, HANGZHOU (CN); Kui XIONG, HANGZHOU (CN)

(21) Appl. No.: 16/601,103

(22) Filed: Oct. 14, 2019

(30) Foreign Application Priority Data
Oct. 15, 2018 (CN) 201811194956.4

(51) Int. Cl. G06F 16/951; G06F 16/2458; G06F 16/14; G06F 16/953; G06F 16/2457

(52) U.S. Cl. CPC G06F 16/951; G06F 16/2465; G06F 2216/03; G06F 16/953; G06F 16/24578; G06F 16/148

(57) ABSTRACT

Embodiments of the present application provide a mining method, system, and a storage medium for mining search results. The search mining method for mining search results comprises: in response to a search request for an object, determining a plurality of files associated with the object; performing a clustering operation on the plurality of files to determine one or more first events, wherein each of the one or more first events is associated with one or more of the plurality of files; and performing a screening operation on the one or more first events to determine one or more second events associated with the object.

### CROSS REFERENCE TO RELATED APPLICATION

The present application is based on and claims priority to Chinese Patent Application No. 201811194956.4, filed on Oct. 15, 2018, which is incorporated herein by reference in its entirety.

### TECHNICAL FIELD

Embodiments of the present application relate to the field of Internet technologies, and in particular, to a mining method, system, and a storage medium for mining search results in response to search requests.

### BACKGROUND

When a user uses a search engine to perform a search for an object, e.g., a character, a video, a piece of music, or the like, the user expects to read important historic events associated with the object and related introductions to understand the character or the beginning and subsequent development of the video, the piece of music, or the like.

From search results of current mainstream search engines, only a large amount of text introduction associated with the searched objects (such as a character, a video, a piece of music, or the like) and related webpage results are returned. A user needs to look for and mine related information by his/herself, which is not efficient nor user-friendly. For example, when the user searches for “Ma Yun,” encyclopedia and related other results regarding “Ma Yun” will appear in the search results by current mainstream search engines. However, the information about “Ma Yun” in these search results is scattered, and the user needs to search for and mine the information by his/herself. As there is no structured information developed, the user experience in searching suffers.

### SUMMARY

Current search engines provide search results in response to search requests. However the search results usually don't form structured information associated with the objects being searched, leading to poor user experience in searching. An objective of the embodiments of the present application is to provide a mining method, a system, and a storage medium for mining search results to solve the above problem.

According to a first aspect of the embodiments of the present application, a search mining method for mining search results is provided. The method comprises: in response to a search request for an object, determining a plurality of files associated with the object; performing a clustering operation on the plurality of files to determine one or more first events, wherein each of the one or more first events is associated with one or more of the plurality of files; and performing a screening operation on the one or more first events to determine one or more second events associated with the object.

In some embodiments, the determining a plurality of files associated with the object may comprise: sorting files crawled by a search engine based on a number of occurrences of the object in a title and a body text of each of the files, to obtain a sorted list of the files crawled by the search engine; and determining a plurality of files associated with the object based on the sorted list.

In some embodiments, the performing a clustering operation on the plurality of files to determine the one or more first events may comprise: determining, for every two files in the plurality of files, a similarity between the two files; and determining, in response to the similarity between the two files being greater than a preset similarity threshold, that the two files are associated with a first event.

In some embodiments, the determining a similarity between the two files may comprise: determining a first similarity between body texts of the two files, a second similarity between the objects included in the body texts of the two files, a third similarity between titles of the two files, and a fourth similarity between the objects included in the titles of the two files; and determining the similarity between the two files based on the first similarity, the second similarity, the third similarity, and the fourth similarity.

In some embodiments, the determining a first similarity between body texts of the two files may comprise: generating a first character vector and a first word vector of the body text of a first file of the two files; generating a second character vector and a second word vector of the body text of a second file of the two files; determining a fifth similarity between the first character vector and the second character vector, and a sixth similarity between the first word vector and the second word vector; and based on the fifth similarity and the sixth similarity, determining the first similarity between the body texts of the two files.

In some embodiments, the determining a second similarity between the objects included in the body texts of the two files may comprise: generating a first vector of the object included in the body text of a first file of the two files; generating a second vector of the object included in the body text of a second file of the two files; and based on the first vector and the second vector, determining the second similarity between the objects included in body texts of the two files.

In some embodiments, the determining a third similarity between titles of the two files may comprise: generating a first character vector and a first word vector of the title content of a first file of the two; generating a second character vector and a second word vector of the title content of a second file of the two files; determining a seventh similarity between the first character vector and the second character vector, and an eighth similarity between the first word vector and the second word vector; and based on the seventh similarity and the eighth similarity, determining the third similarity between the titles of the two files.

In some embodiments, the determining a fourth similarity between the objects included in the titles of the two files may comprise: generating a first vector of the object included in the title of a first file of the two files; generating a second vector of the object included in the title of a second file of the two files; and based on the first vector and the second vector, determining the fourth similarity between the objects included in titles of the two files.

In some embodiments, the performing a screening operation on the one or more first events to determine one or more second events associated with the object may comprise, for each first event of the one or more first events: determining, based on a number of files associated with the first event, a popularity of the first event; and in response to the popularity of the first event being greater than a preset popularity threshold, determining the first event to be a second event.

In some embodiments, the method may further comprise: for each second event of the one or more second events, determining a file from one or more files associated with the second event based on a number of occurrences of the object in a title and a body text of the one or more files; and for each second event of the one or more second events, determining the file as a representative file of the second event.

In some embodiments, the method may further comprise: for each second event of the one or more second events, determining a release time of the representative file as the occurrence time of the second event; and based on the occurrence times of the second events, determining an order to present the one or more second events.

According to a second aspect of the embodiments of the present application, a search mining system for mining search results is provided. The system comprises one or more processors and one or more non-transitory computer-readable storage media storing instructions executable by the one or more processors to cause the system to perform operations comprising: in response to a search request for an object, determining a plurality of files associated with the object; performing a clustering operation on the plurality of files to determine one or more first events, wherein each of the one or more first events is associated with one or more of the plurality of files; and performing a screening operation on the one or more first events to determine one or more second events associated with the object.

According to a third aspect of the embodiments of the present application, a storage medium is provided, and computer executable instructions are stored on the storage medium. The computer executable instructions implement the following operations when processed by one or more processors: in response to a search request for an object, determining a plurality of files associated with the object; performing a clustering operation on the plurality of files to determine one or more first events, wherein each of the one or more first events is associated with one or more of the plurality of files; and performing a screening operation on the one or more first events to determine one or more second events associated with the object.

### BRIEF DESCRIPTION OF THE DRAWINGS

To more clearly describe the technical solutions in the embodiments of the present application or in the current technologies, the accompanying drawings to be used in the description of the embodiments or current technologies will be briefly described. Obviously, the accompanying drawings in the description below are merely some embodiments recorded in the embodiments of the present application, and one of ordinary skill in the art may obtain other drawings according to the accompanying drawings.

FIG. 1 is a flow chart of steps of a search mining method for mining search results according to some embodiments of the present application;

FIG. 2 is a flow chart of steps of another search mining method for mining search results according to some embodiments of the present application;

FIG. 3 is a schematic diagram of a search result display interface according to some embodiments of the present application;

FIG. 4 is a structural block diagram of a search mining apparatus for mining search results according to some embodiments of the present application;

FIG. 5 is a structural block diagram of a search mining apparatus for mining search results according to some embodiments of the present application;

FIG. 6 is a schematic structural diagram of an electronic device according to some embodiments of the present application.

### DETAILED DESCRIPTION

To enable one of ordinary skill in the art to better understand the technical solutions in the embodiments of the present application, the technical solutions in the embodiments of the present application will be clearly and completely described below with reference to the accompanying drawings in the embodiments of the present application. It is obvious that the described embodiments are merely some, but not all, embodiments of the present application. Based on the embodiments of the present application, all other embodiments obtainable by one of ordinary skill in the art shall fall within the protection scope of the embodiments of the present application.

FIG. 1 is a flow chart of steps of a search mining method for mining search results according to some embodiments of the present application. As shown in FIG. 1, the search mining method for mining search results in the present embodiment may comprise the following steps:

In step 101, in response to a search request for an object, determining a plurality of files associated with the object.

In some embodiments, the object may include character name, location name, institution name, song title, movie name, drug name, novel title, title of a literature piece, and the like. The file may be a computer file that stores data. In embodiment, the file is a webpage, such as a dynamic webpage associated with the object. The description above is merely exemplary and is not limited by the embodiments of the present application in any way.

In a specific example, a user inputs an object to be searched in a dialog box of a browser and then clicks a related search button. In response to the search request from the user on the object, a search engine determines a plurality of files associated with the object.

In some embodiments, when determining a plurality of files associated with the object, files crawled by a search engine are sorted based on a number of occurrences of the object in titles and body texts of the files, to obtain a sorted list of the files crawled by the search engine. Accordingly, a plurality of files associated with the object are determined based on the sorted list. In this way, a plurality of files associated with the object may be determined.

In a specific example, when the files crawled by a search engine are sorted, sorting scores of the files crawled by the search engine are determined based on a number of occurrences of the object in titles and body texts of the files. The files crawled by the search engine are sorted based on the sorting scores of the files crawled by the search engine to obtain a sorted list of the files crawled by the search engine. Specifically, the sorting scores of the files crawled by the search engine may be determined through Equation I below:

W=w₁*Sum(t)+w₂*Sum(c) Equation I

Here, W represents a sorting score of a file crawled by the search engine, Sum(t) represents a number of occurrences of the object in the title of a file crawled by the search engine, Sum(c) represents a number of occurrences of the object in the body text of a file crawled by the search engine, and w1 and w2 are artificially assigned weight coefficients, respectively. After sorting scores of the files crawled by the search engine are determined, the files crawled by the search engine are sorted based on the sorting scores of the files crawled by the search engine. After the sorted list of the files crawled by the search engine is determined, the top N files are selected as a plurality of files associated with the object.

In step 102, a clustering operation is performed on the plurality of files to determine one or more first events, wherein each of the one or more first events is associated with one or more of the plurality of files.

In some embodiments, when a clustering operation is performed on the plurality of files to determine first, for every two files in the plurality of files, a similarity between the two files is determined. If the similarity between the two files is greater than a preset similarity threshold, it is determined that the two files are associated with the same event. Here, the preset similarity threshold may be set by those skilled in the art according to empirical values, which is not limited by the embodiments of the present application in any way. It should be understood that any suitable manner of performing a clustering operation on the plurality of files to determine first events may be applicable herein, which is not limited by the embodiments of the present application in any way.

In a specific example, for every two files in the plurality of files, if a similarity between the two files is greater than a preset similarity threshold, it is determined that the two files belong to the same clustering set. In this way, the plurality of files is clustered into a plurality of clustering sets. Here, each clustering set may be referred to as an event, and a file associated with one event may belong to the clustering set corresponding to the event.

In some embodiments, when a similarity between two files is determined, a first similarity between body texts, a second similarity between the objects included in the body texts, a third similarity between title contents, and a fourth similarity between the objects included in the titles of the two files are determined. Accordingly, the similarity between the two files is determined based on the first similarity, the second similarity, the third similarity, and the fourth similarity. In this way, a similarity between two files may be accurately determined. It should be understood that any implementation manner of determining a similarity between two files may be applicable herein, which is not limited by the embodiments of the present application in any way.

In a specific example, a similarity between the two files may be determined through Equation II below:

S=w₁*SC(c)+w₂*SC(e)+w₃* ST (c)+w₄* ST (e) Equation II

Here, S represents a similarity between the two files, SC(c) represents the first similarity, SC(e) represents the second similarity, ST(c) represents the third similarity, ST(e) represents the fourth similarity, and w1, w2, w3, w4 represent artificially designated weight coefficients, respectively. It should be understood that the description above is merely exemplary and is not limited by the embodiments of the present application in any way.

In some embodiments, to determine the first similarity between body texts of the two files, a character vector and a word vector of the body text of a first file of the two files are generated for the first file; a character vector and a word vector of the body text of a second file of the two files are generated for the second file; a fifth similarity between the character vector of the body text of the first file and the character vector of the body text of the second file is determined, and a sixth similarity between the word vector of the body text of the first file and the word vector of the body text of the second file is determined; and based on the fifth similarity and the sixth similarity, the first similarity between body texts of the two files is determined. In this way, a similarity between body texts of two files can be accurately determined. It should be understood that any implementation manner of determining a similarity between body texts of two files may be applicable herein, which is not limited by the embodiments of the present application in any way.

In a specific example, each dimension of the character vector may be characterized by using a character mark and a number of occurrences of the character in the body text of a file, each dimension of the word vector may be characterized by using a word mark and a number of occurrences of the word in the body text of the file, and the fifth similarity, the sixth similarity, and the first similarity may be characterized by using cosine similarity, respectively. Optionally, the fifth similarity and the sixth similarity may be added to obtain the first similarity between body texts of two files. Alternatively, the first similarity between body texts of two files may be obtained by calculating an average of the fifth similarity and the sixth similarity. It should be understood that the description above is merely exemplary and is not limited by the embodiments of the present application in any way.

In some embodiments, to determine the second similarity between the objects included in body texts of the two files, a first vector of the object included in the body text of a first file of the two files is generated for the first file; a second vector of the object included in the body text of a second file of the two files is generated for the second file; and based on the first vector and the second vector, the second similarity between the objects included in body texts of the two files is determined. In this way, a similarity between objects included in body texts of two files can be accurately determined. It should be understood that any implementation manner of determining a similarity between objects included in body texts of two files may be applicable herein, which is not limited by the embodiments of the present application in any way.

In a specific example, each dimension of the vector of an object included in the body text of a file may be characterized by using an object mark and a number of occurrences of the object in the body text of the file, and the second similarity may be characterized by using cosine similarity. It should be understood that the description above is merely exemplary and is not limited by the embodiments of the present application in any way.

In some embodiments, to determine the third similarity between title contents of the two files, a character vector and a word vector of the title content of a first file of the two files are generated for the first file; a character vector and a word vector of the title content of a second file of the two files are generated for the second file; a seventh similarity between the character vector of the title content of the first file and the character vector of the title content of the second file is determined, and an eighth similarity between the word vector of the title content of the first file and the word vector of the title content of the second file is determined; and based on the seventh similarity and the eighth similarity, the third similarity between title contents of the two files may be determined. In this way, a similarity between title contents of two files can be accurately determined. It should be understood that any implementation manner of determining a similarity between title contents of two files may be applicable herein, which is not limited by the embodiments of the present application in any way.

In a specific example, each dimension of the character vector may be characterized by using a character mark and a number of occurrences of the character in the title content of a file, each dimension of the word vector may be characterized by using a word mark and a number of occurrences of the word in the title content of the file, and the seventh similarity, the eighth similarity, and the third similarity may be characterized by using cosine similarity, respectively. Optionally, the seventh similarity and the eighth similarity may be added to obtain the third similarity between title contents of two files. Alternatively, the third similarity between title contents of two files may be obtained by calculating an average of the seventh similarity and the eighth similarity. It should be understood that the description above is merely exemplary and is not limited by the embodiments of the present application in any way.

In some embodiments, to determine the fourth similarity between the objects included in titles of the two files, a third vector of the object included in the title of a first file of the two files is generated for the first file; a fourth vector of the object included in the title of a second file of the two files is generated for the second file; and based on the third vector and the fourth vector, the fourth similarity between the objects included in titles of the two files may be determined. In this way, a similarity between objects included in titles of two files can be accurately determined. It should be understood that any implementation manner of determining a similarity between objects included in titles of two files may be applicable herein, which is not limited by the embodiments of the present application in any way.

In a specific example, each dimension of the vector of an object included in the title of a file may be characterized by using an object mark and a number of occurrences of the object in the title of the file, and the fourth similarity may be characterized by using cosine similarity.

In a specific example, crawled files may be parsed by using a web crawler in a search engine to obtain titles and body texts of the files, characters and words in the titles, characters and words in the body texts, objects included in the titles, and objects included in the body texts.

In some embodiments, to determine a similarity between two files, the first similarity between body texts of the two files and the second similarity between the objects included in the body texts of the two files are determined; based on the first similarity and the second similarity, a similarity between the two files may be determined. In this way, a similarity between two files can be accurately determined. It should be understood that any implementation manner of determining a similarity between two files may be applicable herein, which is not limited by the embodiments of the present application in any way.

In some optional embodiments, to determine a similarity between two files, the third similarity between title contents of the two files and the fourth similarity between the objects included in the titles of the two files are determined; based on the third similarity and the fourth similarity, a similarity between the two files may be determined. In this way, a similarity between two files can be accurately determined. It should be understood that any implementation manner of determining a similarity between two files may be applicable herein, which is not limited by the embodiments of the present application in any way.

In step 103, a screening operation is performed on the one or more first events to determine one or more second events associated with the object.

The search mining method for mining search results in the present embodiment may be implemented by any proper devices having data processing capabilities, including but not limited to a camera, a terminal, a mobile terminal, a PC, a server, a vehicle-mounted device, an entertainment device, an advertising device, a personal digital assistant (PDA), a tablet computer, a laptop computer, a handheld gaming device, smart glasses, a smart watch, a wearable device, a virtual display device, or a display enhancement device (such as Google Glass, Oculus Rift, Hololens, Gear VR, etc.).

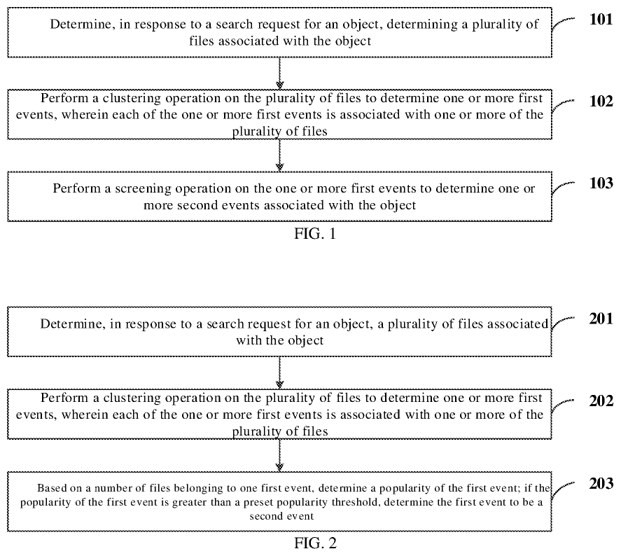

FIG. 2 is a flow chart of steps of another search mining method for mining search results according to some embodiments of the present application.

The search mining method for mining search results in the present embodiment comprises the following steps:

In step 201, in response to a search request for an object, a plurality of files associated with the object are determined. Step 201 is similar to the above-described step 101.

In step 202, a clustering operation is performed on the plurality of files to determine one or more first events, wherein each of the one or more first events is associated with one or more of the plurality of files. Step 202 is similar to the above-described step 102.

In step 203, based on a number of files associated with a first event, determine a popularity of the first event; if the popularity of the first event is greater than a preset popularity threshold, determine the first event to be a second event.

In some embodiments, the popularity of the first event may be determined through Equation III below:

H=Count(e) Equation III

Here, H represents the popularity of the first event, e represents a file associated with the first event, and Count(e) represents a number of files associated with the first event. In addition, the preset popularity threshold may be set by those skilled in the art according to empirical values, which is not limited by the embodiments of the present application in any way.

In a specific example, if the popularity of one first event with which a plurality of files are associated is smaller than or equal to the preset popularity threshold, the first event is determined not to be a second event associated with the object. If the popularity of the first event is greater than the preset popularity threshold, the first event are determined to be a second event associated with the object. It should be understood that the description above is merely exemplary and is not limited by the embodiments of the present application in any way.

In some embodiments, the method further comprises: based on a number of occurrences of the object in titles and body texts of the files, determining a file in the files associated with the second event that has the strongest correlation with the object, and determining the file that has the strongest correlation with the object as a representative file of the second event. In this way, the user can conveniently and promptly understand the content of the second event.

In a specific example, to determine a file in the files associated with the second event that has the strongest correlation with the object, the numbers of occurrences of the object in the title and body text of each file associated with the second event are counted; a file having a highest sum of the number of occurrences of the object in the title and the number of occurrences of the object in the body text is determined as the file that has the strongest correlation with the object.

In some embodiments, the method further comprises: determining a release time of the representative file as the occurrence time of the second event; and based on the occurrence times of the second events, determining an order to present the second events. In this way, the occurrence time of an event can be accurately determined, and moreover, an order to present the events can be accurately determined. It should be understood that the description above is merely exemplary and is not limited by the embodiments of the present application in any way.

In some embodiments, the method further comprises: based on the popularity of one or more second events, determining an order to present these second events. In this way, an order to present events can be accurately determined. It should be understood that the description above is merely exemplary and is not limited by the embodiments of the present application in any way.

In a specific example, when a user uses an object to search in a search engine, the search engine uses the search mining method for mining search results provided in the embodiments of the present application to determine a set of events associated with the object and to present the set of events associated with the object for inquiries by the user. In addition, a file in the files associated with the event that has the strongest correlation with the object is selected as a representative file of the event, and the representative file is presented for inquiries by the user.

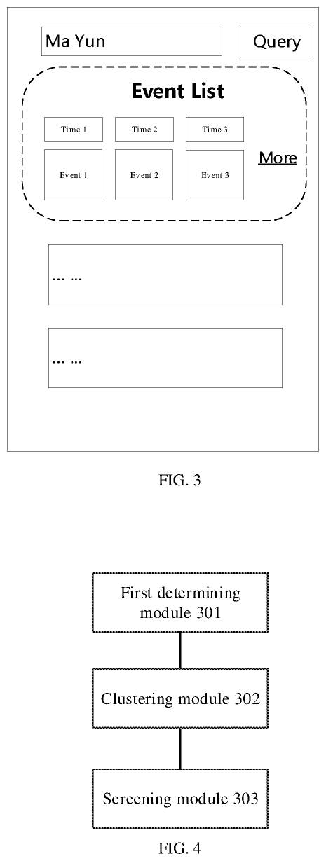

FIG. 3 is a schematic diagram of a search result display interface according to some embodiments of the present application. As shown in FIG. 3, when the user searches for “Ma Yun,” a set of representative events is selected from the files according to the technical solution of the present application, and the events are sorted and presented in an order of occurrence times for inquiries by the user.

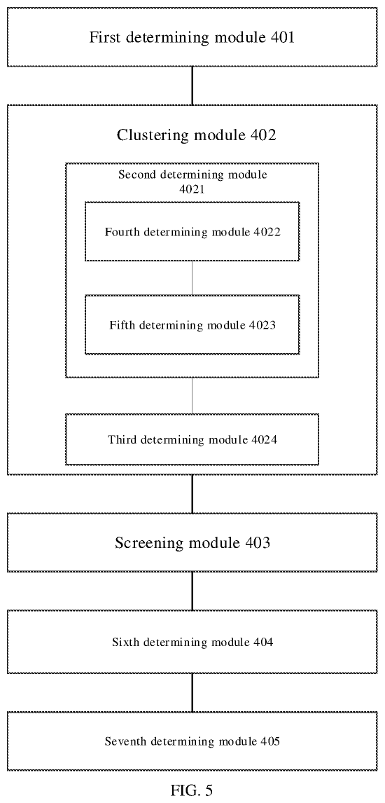

FIG. 4 is a structural block diagram of a search mining apparatus for mining search results according to some embodiments of the present application.

The mining apparatus for searching in the present embodiment comprises: a first determining module 301 configured to determine, in response to a search request for an object, a plurality of files associated with the object; a clustering module 302 configured to perform a clustering operation on the plurality of files to determine one or more first events with which the plurality of files are associated with, respectively; and a screening module 303 configured to perform a screening operation on the first events to determine one or more second events associated with the object.

The mining apparatus for searching in the present embodiment is configured to implement the corresponding search mining method for mining search results in the above-described plurality of method embodiments, and achieves advantageous effects of the corresponding method embodiments, which will not be elaborated herein.

FIG. 5 is a structural block diagram of a search mining apparatus for mining search results according to some embodiments of the present application.

The mining apparatus for searching in the present embodiment comprises: a first determining module 401 configured to determine, in response to a search request for an object, a plurality of files associated with the object; a clustering module 402 configured to perform a clustering operation on the plurality of files to determine one or more first events with which the plurality of files are associated with, respectively; and a screening module 403 configured to perform a screening operation on the first events to determine one or more second event associated with the object.

In some embodiments, the first determining module 401 is specifically configured to sort files crawled by the search engine, based on a number of occurrences of the object in titles and body texts of the files, to obtain a sorted list of the files crawled by the search engine; and determine a plurality of files associated with the object based on the sorted list.

In some embodiments, the clustering module 402 comprises a second determining module 4021 configured to determine, for every two files in the plurality of files, a similarity between the two files; and a third determining module 4024 configured to determine, if the similarity between the two files is greater than a preset similarity threshold, that the two files may be determined as being associated with the same event.

In some embodiments, the second determining module 4021 comprises a fourth determining module 4022 configured to determine a first similarity between body texts, a second similarity between the objects included in the body texts, a third similarity between title contents, and a fourth similarity between the objects included in the titles of the two files; and a fifth determining module 4023 configured to determine the similarity between the two files based on the first similarity, the second similarity, the third similarity, and the fourth similarity.

In some embodiments, the fourth determining module 4022 is specifically configured to generate a character vector and a word vector of the body text of a first file of the two files for the first file; generate a character vector and a word vector of the body text of a second file of the two files for the second file; determine a fifth similarity between the character vector of the body text of the first file and the character vector of the body text of the second file, and a sixth similarity between the word vector of the body text of the first file and the word vector of the body text of the second file; and based on the fifth similarity and the sixth similarity, determine the first similarity between body texts of the two files.

In some embodiments, the fourth determining module 4022 is specifically configured to generate a first vector of the object included in the body text of a first file of the two files for the first file; generate a second vector of the object included in the body text of a second file of the two files for the second file; and based on the first vector and the second vector, determine the second similarity between the objects included in body texts of the two files.

In some embodiments, the fourth determining module 4022 is specifically configured to generate a character vector and a word vector of the title content of a first file of the two files for the first file; generate a character vector and a word vector of the title content of a second file of the two files for the second file; determine a seventh similarity between the character vector of the title content of the first file and the character vector of the title content of the second file, and an eighth similarity between the word vector of the title content of the first file and the word vector of the title content of the second file; and based on the seventh similarity and the eighth similarity, determine the third similarity between title contents of the two files.

In some embodiments, the fourth determining module 4022 is specifically configured to generate a third vector of the object included in the title of a first file of the two files for the first file; generate a fourth vector of the object included in the title of a second file of the two files for the second file; and based on the third vector and the fourth vector, determine the fourth similarity between the objects included in titles of the two files.

In some embodiments, the screening module 403 is specifically configured to determine, based on a number of files associated with a first event, a popularity of the first event; and if the popularity of the first event is greater than a preset popularity threshold, determine the first event to be a second event.

In some embodiments, the apparatus further comprises: a sixth determining module 404 configured to determine, based on a number of occurrences of the object in titles and body texts of the files, a file in the files associated with the second event that has the strongest correlation with the object, and determine the file that has the strongest correlation with the object as a representative file of the second event.

In some embodiments, the apparatus further comprises: a seventh determining module 405 configured to determine a release time of the representative file as the occurrence time of the second event, and based on the occurrence times of the second events, determine an order to present the second events.

The mining apparatus for searching in the present embodiment is configured to implement the corresponding search mining method for mining search results in the above-described plurality of method embodiments, and achieves advantageous effects of the corresponding method embodiments, which will not be elaborated herein.

Another embodiment of the present application provides a storage medium, and a computer executable instruction is stored on the storage medium. The computer executable instruction implements the following steps when processed by a processor: in response to a search operation on an inputted object, determining a plurality of files associated with the object; performing a clustering operation on the plurality of files to determine one or more first events with which the plurality of files are associated, respectively; and performing a screening operation on the first events to determine one or more second events associated with the object.

Another embodiment of the present application provides an electronic device, comprising: one or more processors; and a memory configured to store one or more programs; when executed by the one or more processors, the one or more programs cause the one or more processors to implement the above-described search mining method for mining search results in any of the above-described embodiments.

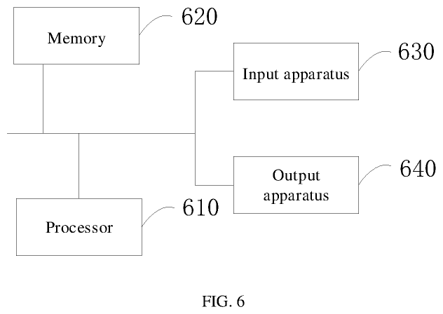

FIG. 6 is a schematic structural diagram of an electronic device according to some embodiments of the present application. As shown in FIG. 6, the device comprises: one or more processors 610 and a memory 620. In FIG. 6, the processor 610 is used as an example. The device for implementing the above-described method may further comprise an input apparatus 630 and an output apparatus 640. The processor 610, memory 620, input apparatus 630 and output apparatus 640 may be connected via a bus or in other manners. In FIG. 6, the bus connection is used as an example.

As a non-volatile computer readable storage medium, the memory 620 may be used to store non-volatile software programs, non-volatile computer executable programs and modules, such as program instructions/modules corresponding to the above-described method in the embodiments of the present application. By running the non-volatile software programs, instructions and modules stored in the memory 620, the processor 610 executes various functional applications and data processing of a server, i.e., implementing the above-described method in the method embodiments.

The memory 620 may comprise a stored program region and a stored data region, wherein the stored program region may store an operating system and applications required by at least one function; the stored data region may store events associated with objects, and the like. In addition, the memory 620 may comprise a high-speed random-access memory or a non-volatile memory, for example, at least one magnetic disk storage device, a flash memory device, or other non-volatile solid-state storage devices. In some embodiments, the memory 620 optionally comprises a memory arranged remotely relatively to the processor 610. The remote memory may be connected to a client via a network. Examples of the above network include, but are not limited to, the Internet, Intranet, local area network, mobile communication network, and a combination thereof.

The input apparatus 630 may receive inputted number or character information and generate key signal inputs related to user settings and function control of a client. The input apparatus 630 may comprise devices such as a pressing module.

The one or more modules are stored in the memory 620, and when executed by the one or more processors 610, implement the above-described method in any of the above-described method embodiments.

The above product may be equipped with corresponding functional modules for implementing the method, and implement the method provided in the embodiments of the present application to achieve advantageous effects.

The electronic device in the embodiments of the present application may be present in various forms, including but not limited to:

(1) Mobile communication devices: this type of devices is characterized by mobile communication capabilities with the main goal to provide voice and data communications. This type of terminals includes: smart phones (e.g., iPhone), multimedia mobile phones, functional mobile phones, and low-end mobile phones.

(2) Ultra mobile personal computer devices: this type of devices falls in the category of personal computers, which have computing and processing functions, and typically also have mobile Internet access features. This type of terminals includes: PDA, MID and UMPC devices, e.g., iPad.

(3) Portable entertainment devices: this type of devices may display and play multimedia contents. This type of devices includes audio and video players (e.g., iPod), handheld gaming devices, e-books, smart toys, and portable vehicle-mounted navigation devices.

(4) Servers: devices that provide computation services. A server includes a processor 71, a hard drive, a memory, a system bus, and the like. The server is similar to the general computer architecture, but has higher requirements for processing capabilities, stability, reliability, security, scalability, manageability, and the like due to the need for provision of highly reliable services.

(5) Other electronic apparatuses with data exchange capabilities.

The above-described apparatus embodiments are merely exemplary, wherein modules described as separate parts may or may not be physically separated, and parts displayed as modules may or may not be physical modules, i.e., they may be disposed at the same location or may be spread to a plurality of network modules. Some or all modules thereof may be selected according to actual needs to achieve the objectives of the solutions of these embodiments. One of ordinary skill in the art may understand and implement these embodiments without inventive effort.

With the above description of the implementation manners, those skilled in the art may clearly understand that all the implementation manners may be achieved through software plus a necessary general hardware platform or may be achieved through hardware. Based on such understanding, the above technical solutions, in essence, or the portion thereof that contributes to the current technologies, may be embodied in the form of a software product. The computer software product may be stored in a computer readable storage medium. The computer readable storage medium includes any mechanism that stores or transfers information in the computer (e.g., a computer) readable form. For example, the machine-readable medium includes a Read-Only Memory (ROM), a Random-Access Memory (RAM), a magnetic disk storage medium, an optical storage medium, a flash storage medium, a propagating signal in the form of electricity, light, sound, or other forms (e.g., a carrier, an infrared signal, a digital signal, etc.). The computer software product includes several instructions to cause a computer device (which may be a personal computer, a server, or a network device) to execute methods according to the embodiments or some parts of the embodiments.

Those skilled in the art should understand that the embodiments of the present application may be provided as a method, an apparatus (device), or a computer program product. Therefore, the embodiments of the present application may be in the form of a complete hardware embodiment, a complete software embodiment, or an embodiment combining software and hardware. Moreover, the embodiments of the present application may be in the form of a computer program product implemented on one or more computer usable storage media (including, but not limited to, a magnetic disk memory, CD-ROM, an optical memory, etc.) comprising computer usable program codes.

The embodiments of the present application are described with reference to flowcharts and/or block diagrams of the method, apparatus (device), and computer program product according to the embodiments of the present application. It should be understood that a computer program instruction may be used to implement each process and/or block in the flowcharts and/or block diagrams and a combination of processes and/or blocks in the flowcharts and/or block diagrams. These computer program instructions may be provided for a general-purpose computer, a special-purpose computer, an embedded processor, or a processor of other programmable data processing devices to generate a machine, causing the instructions to be executed by a computer or a processor of other programmable data processing devices to generate an apparatus for implementing a function specified in one or more processes in the flowcharts and/or in one or more blocks in the block diagrams.

These computer program instructions may also be stored in a computer readable memory that can instruct a computer or other programmable data processing devices to work in a particular manner The computer readable memory with the instructions stored therein can be considered as a manufactured article, e.g., an instruction apparatus. The instruction apparatus implements a function specified in one or more processes in the flowcharts and/or in one or more blocks in the block diagrams.

These computer program instructions may also be loaded onto a computer or other programmable data processing devices, causing a series of operational steps to be executed on the computer or other programmable devices, thereby generating computer-implemented processing. Therefore, the instructions executed on the computer or other programmable devices provide steps for implementing a function specified in one or more processes in the flowcharts and/or in one or more blocks in the block diagrams.

Finally, it should be noted that the above embodiments are merely used to describe, rather than limit, the technical solutions of the embodiments of the present application. Although the present application is described in detail with reference to the above embodiments, one of ordinary skill in the art should understand that the technical solutions in the above-described embodiments may still be amended or some technical features thereof may be equivalently substituted, while these amendments or substitutions do not cause the essence of corresponding technical solutions to depart from the spirit and scope of the technical solutions in the embodiments of the present application.

What is claimed is:

1. A search mining method for mining search results, comprising:
in response to a search request for an object, determining a plurality of files associated with the object;
performing a clustering operation on the plurality of files to determine one or more first events, wherein each of the one or more first events is associated with one or more of the plurality of files; and
performing a screening operation on the one or more first events to determine one or more second events associated with the object.

2. The method according to claim 1, wherein the determining a plurality of files associated with the object comprises:
sorting files crawled by a search engine based on a number of occurrences of the object in a title and a body text of each of the files, to obtain a sorted list of the files crawled by the search engine; and
determining a plurality of files associated with the object based on the sorted list.

3. The method according to claim 1, wherein the performing a clustering operation on the plurality of files to determine the one or more first events comprises:
determining, for every two files in the plurality of files, a similarity between the two files; and
determining, in response to the similarity between the two files being greater than a preset similarity threshold, that the two files are associated with a first event.

4. The method according to claim 3, wherein the determining a similarity between the two files comprises:
determining a first similarity between body texts of the two files, a second similarity between the objects included in the body texts of the two files, a third similarity between titles of the two files, and a fourth similarity between the objects included in the titles of the two files; and
determining the similarity between the two files based on the first similarity, the second similarity, the third similarity, and the fourth similarity.

5. The method according to claim 4, wherein the determining a first similarity between body texts of the two files comprises:
generating a first character vector and a first word vector of the body text of a first file of the two files;
generating a second character vector and a second word vector of the body text of a second file of the two files;
determining a fifth similarity between the first character vector and the second character vector, and a sixth similarity between the first word vector and the second word vector; and
based on the fifth similarity and the sixth similarity, determining the first similarity between the body texts of the two files.

6. The method according to claim 4, wherein the determining a second similarity between the objects included in the body texts of the two files comprises:
generating a first vector of the object included in the body text of a first file of the two files;
generating a second vector of the object included in the body text of a second file of the two files; and
based on the first vector and the second vector, determining the second similarity between the objects included in body texts of the two files.

7. The method according to claim 4, wherein the determining a third similarity between titles of the two files comprises:
generating a first character vector and a first word vector of the title content of a first file of the two files;
generating a second character vector and a second word vector of the title content of a second file of the two files;
determining a seventh similarity between the first character vector and the second character vector, and an eighth similarity between the first word vector and the second word vector; and
based on the seventh similarity and the eighth similarity, determining the third similarity between the titles of the two files.

8. The method according to claim 4, wherein the determining a fourth similarity between objects included in the titles of the two files comprises:
generating a first vector of the object included in the title of a first file of the two files;
generating a second vector of the object included in the title of a second file of the two files; and
based on the first vector and the second vector, determining the fourth similarity between the objects included in titles of the two files.

9. The method according to claim 1, wherein the performing a screening operation on the one or more first events to determine one or more second events associated with the object comprises, for each first event of the one or more first events:
determining, based on a number of files associated with the first event, a popularity of the first event; and
in response to the popularity of the first event being greater than a preset popularity threshold, determining the first event to be a second event.

10. The method according to claim 1, further comprising:
for each second event of the one or more second events, determining a file from one or more files associated with the second event based on a number of occurrences of the object in a title and a body text of the one or more files; and
for each second event of the one or more second events, determining the file as a representative file of the second event.

11. The method according to claim 10, further comprising:
for each second event of the one or more second events, determining a release time of the representative file as the occurrence time of the second event; and
based on the occurrence times of the second events, determining an order to present the one or more second events.

12. A search mining system for mining search results comprising one or more processors and one or more non-transitory computer-readable storage media storing instructions executable by the one or more processors to cause the system to perform operations comprising:
in response to a search request for an object, determining a plurality of files associated with the object;
performing a clustering operation on the plurality of files to determine one or more first events, wherein each of the one or more first events is associated with one or more of the plurality of files; and
performing a screening operation on the one or more first events to determine one or more second events associated with the object.

13. The system according to claim 12, wherein the determining a plurality of files associated with the object comprises:
sorting files crawled by a search engine based on a number of occurrences of the object in a title and a body text of each of the files, to obtain a sorted list of the files crawled by the search engine; and
determining a plurality of files associated with the object based on the sorted list.

14. The system according to claim 12, wherein
the performing a clustering operation on the plurality of files to determine the one or more first events comprises:
determining, for every two files in the plurality of files, a similarity between the two files; and
determining, in response to the similarity between the two files being greater than a preset similarity threshold, that the two files are associated with a first event.

15. The system according to claim 14, wherein the determining a similarity between the two files comprises:
determining a first similarity between body texts of the two files, a second similarity between the objects included in the body texts of the two files, a third similarity between titles of the two files, and a fourth similarity between the objects included in the titles of the two files; and
determining the similarity between the two files based on the first similarity, the second similarity, the third similarity, and the fourth similarity.

16. The system according to claim 15, wherein the determining a first similarity between body texts of the two files comprises:
generating a first character vector and a first word vector of the body text of a first file of the two files;
generating a second character vector and a second word vector of the body text of a second file of the two files;
determining a fifth similarity between the first character vector and the second character vector, and a sixth similarity between the first word vector and the second word vector; and
based on the fifth similarity and the sixth similarity, determining the first similarity between the body texts of the two files.

17. The system according to claim 15, wherein the determining a second similarity between the objects included in the body texts of the two files comprises:
generating a first vector of the objects included in the body text of a first file of the two files;
generating a second vector of the objects included in the body text of a second file of the two files; and
based on the first vector and the second vector, determining the second similarity between the objects included in body texts of the two files.

18. The system according to claim 12, wherein the performing a screening operation on the one or more first events to determine one or more second events associated with the object comprises, for each first event of the one or more first events:
determining, based on a number of files associated with the first event, a popularity of the first event; and
in response to the popularity of the first event being greater than a preset popularity threshold, determining the first event to be a second event.

19. The system according to claim 12, wherein the operations further comprise:
for each second event of the one or more second events, determining a file from one or more files associated with the second event based on a number of occurrences of the object in a title and a body text of the one or more files; and
for each second event of the one or more second events, determining the file as a representative file of the second event.

20. A non-transitory computer-readable storage medium for mining search results, configured with instructions executable by one or more processors to cause the one or more processors to perform operations comprising:
in response to a search request for an object, determining a plurality of files associated with the object;
performing a clustering operation on the plurality of files to determine one or more first events, wherein each of the one or more first events is associated with one or more of the plurality of files; and
performing a screening operation on the one or more first events to determine one or more second events associated with the object.
